(19) United States
(12) Patent Application Publication
(10) Pub. No.: US 2026/0261522 A1
(43) Pub. Date: Sep. 3, 2026

(54) Method and Communication Device for Communication Security

(71) Applicant: Telefonaktiebolaget LM Ericsson (publ), Stockholm (SE)

(72) Inventors: Daiying Liu, Beijing (CN); Yiqun Li, Beijing (CN); Chao Zhou, Beijing (CN)

(21) Appl. No.: 18/876,033

(22) PCT Filed: Jul. 22, 2022
(86) PCT No.: PCT/CN2022/107366

§ 371 Date: Dec. 17, 2024

(51) Int. Cl. H04L 47/34; H04L 9/40

(52) U.S. Cl. CPC H04L 47/34; H04L 63/101; H04L 63/1416

(57) ABSTRACT

A method and a communication device are disclosed for communication security. According to an embodiment, when a number of occurrences of an event that a sequence number (SN) of an encapsulating security payload (ESP) packet received by the communication device is outside an anti-replay window, in a first predetermined time period is greater than or equal to a predetermined threshold, or when the SN of an ESP packet received by the communication device is duplicate with the SN of a previously received ESP packet, the communication device determines that an attack has occurred on the communication device.

### TECHNICAL FIELD

Embodiments of the disclosure generally relate to communication, and, more particularly, to a method and a communication device for communication security.

### BACKGROUND

This section introduces aspects that may facilitate better understanding of the present disclosure. Accordingly, the statements of this section are to be read in this light and are not to be understood as admissions about what is in the prior art or what is not in the prior art.

Internet protocol (IP) security (IPsec) provides confidentiality, data integrity, access control, and data source authentication to IP datagrams. These services are provided by maintaining shared state between the source and the sink of an IP datagram. This state defines, among other things, the specific services provided to the datagram, which cryptographic algorithms will be used to provide the services, and the keys used as input to the cryptographic algorithms.

Sequence number (SN) is an unsigned 32-bit field (or 64-bit field for extend sequence number (ESN)) containing a counter value that increases by one for each packet sent, i.e., a per-SA packet sequence number, where the term SA refers to security association. The field is mandatory and must always be present even if the receiver does not elect to enable the anti-replay service for a specific SA. Processing of the Sequence Number field is at the discretion of the receiver, but all encapsulating security payload (ESP) implementations must be capable of performing the processing. Thus, the sender must always transmit this field, but the receiver may not need to act upon it.

All ESP implementations must support the anti-replay service, though its use may be enabled or disabled by the receiver on a per-SA basis. This service must not be enabled unless the ESP integrity service also is enabled for the SA, because otherwise the Sequence Number field has not been integrity protected. If the receiver has enabled the anti-replay service for this SA, the reception packet counter for the SA must be initialized to zero when the SA is established. For each received packet, the receiver must verify that the packet contains a Sequence Number that does not duplicate the Sequence Number of any other packets received during the life of this SA.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for communication security. In particular, one of the problems to be solved by the disclosure is that the existing solution for communication security may treat normal packets as attacks in some cases. Another problem to be solved by the disclosure is that the existing solution for communication security may not work normally when there are a large number of attack packets.

According to a first aspect of the disclosure, there is provided a method performed by a communication device. The method may comprise, when a number of occurrences of an event that a sequence number (SN) of an encapsulating security payload (ESP) packet received by the communication device is outside an anti-replay window, in a first predetermined time period is greater than or equal to a predetermined threshold, or when the SN of an ESP packet received by the communication device is duplicate with the SN of a previously received ESP packet, determining that an attack has occurred on the communication device.

In this way, it is possible to detect the attack more accurately thereby reducing false detection probability.

In an embodiment of the disclosure, the method may further comprise, when determining that an attack has occurred on the communication device, determining an access control list (ACL) that is to be applied to a forwarding plane of the communication device to drop at least one ESP packet related to the attack, based on the anti-replay window by which the attack is determined to have occurred on the communication device or based on the duplicate SN. The method may further comprise applying the ACL to the forwarding plane.

In this way, the normal ESP packets can be processed efficiently even when there are a large number of attack packets.

In an embodiment of the disclosure, the ACL may instruct the forwarding plane to drop at least one ESP packet satisfying following conditions: a security parameters index (SPI) value of the at least one ESP packet is equal to the SPI value of a security association (SA) for which the attack is determined to have occurred on the communication device; a source Internet protocol (IP) address of the at least one ESP packet is the same as the source IP address of the SA; a destination IP address of the at least one ESP packet is the same as the destination IP address of the SA; and the SN of the at least one ESP packet is less than a lower edge of the anti-replay window by which the attack is determined to have occurred on the communication device, or is less than or equal to the duplicate SN.

In an embodiment of the disclosure, the method may further comprise, when a number of ESP packets dropped by the forwarding plane according to the ACL does not increase in a second predetermined time period, or when rekeying occurs, removing the ACL from the forwarding plane.

In an embodiment of the disclosure, the method may further comprise, when determining that a new attack different than a previous attack has occurred on the communication device, determining an updated ACL that is to be applied to the forwarding plane to drop at least one ESP packet related to both the new attack and the previous attack, based on a new anti-replay window by which the new attack is determined to have occurred on the communication device or based on a new duplicate SN. The method may further comprise applying the updated ACL to the forwarding plane.

In an embodiment of the disclosure, the updated ACL may instruct the forwarding plane to drop at least one ESP packet satisfying following conditions: the SPI value of the at least one ESP packet is equal to the SPI value of the SA for which the new attack is determined to have occurred on the communication device; the source IP address of the at least one ESP packet is the same as the source IP address of the SA; the destination IP address of the at least one ESP packet is the same as the destination IP address of the SA; and the SN of the at least one ESP packet is less than the lower edge of the new anti-replay window by which the new attack is determined to have occurred on the communication device, or is less than or equal to the new duplicate SN.

In an embodiment of the disclosure, the communication device may be capable of supporting Internet protocol security (IPSec).

In an embodiment of the disclosure, the communication device may be one of: a security gateway; a firewall; a router; a server; and a user equipment.

According to a second aspect of the disclosure, there is provided a communication device. The communication device may comprise at least one processor and at least one memory. The at least one memory may contain instructions executable by the at least one processor, whereby the communication device may be operative to, when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, determine that an attack has occurred on the communication device.

In this way, it is possible to detect the attack more accurately thereby reducing false detection probability.

In an embodiment of the disclosure, the communication device may be further operative to, when determining that an attack has occurred on the communication device, determine an ACL that is to be applied to a forwarding plane of the communication device to drop at least one ESP packet related to the attack, based on the anti-replay window by which the attack is determined to have occurred on the communication device or based on the duplicate SN. The communication device may be further operative to apply the ACL to the forwarding plane.

In this way, the normal ESP packets can be processed efficiently even when there are a large number of attack packets.

In an embodiment of the disclosure, the ACL may instruct the forwarding plane to drop at least one ESP packet satisfying following conditions: an SPI value of the at least one ESP packet is equal to the SPI value of a SA for which the attack is determined to have occurred on the communication device; a source IP address of the at least one ESP packet is the same as the source IP address of the SA; a destination IP address of the at least one ESP packet is the same as the destination IP address of the SA; and the SN of the at least one ESP packet is less than a lower edge of the anti-replay window by which the attack is determined to have occurred on the communication device, or is less than or equal to the duplicate SN.

In an embodiment of the disclosure, the communication device may be further operative to, when a number of ESP packets dropped by the forwarding plane according to the ACL does not increase in a second predetermined time period, or when rekeying occurs, remove the ACL from the forwarding plane.

In an embodiment of the disclosure, the communication device may be further operative to, when determining that a new attack different than a previous attack has occurred on the communication device, determine an updated ACL that is to be applied to the forwarding plane to drop at least one ESP packet related to both the new attack and the previous attack, based on a new anti-replay window by which the new attack is determined to have occurred on the communication device or based on a new duplicate SN. The communication device may be further operative to apply the updated ACL to the forwarding plane.

In an embodiment of the disclosure, the updated ACL may instruct the forwarding plane to drop at least one ESP packet satisfying following conditions: the SPI value of the at least one ESP packet is equal to the SPI value of the SA for which the new attack is determined to have occurred on the communication device; the source IP address of the at least one ESP packet is the same as the source IP address of the SA; the destination IP address of the at least one ESP packet is the same as the destination IP address of the SA; and the SN of the at least one ESP packet is less than the lower edge of the new anti-replay window by which the new attack is determined to have occurred on the communication device, or is less than or equal to the new duplicate SN.

In an embodiment of the disclosure, the communication device may be capable of supporting IPSec.

In an embodiment of the disclosure, the communication device may be one of: a security gateway; a firewall; a router; a server; and a user equipment.

According to a third aspect of the disclosure, there is provided a computer program product. The computer program product may contain instructions which when executed by at least one processor, cause the at least one processor to perform the method according to the above first aspect.

According to a fourth aspect of the disclosure, there is provided a computer readable storage medium. The computer readable storage medium may store thereon instructions which when executed by at least one processor, cause the at least one processor to perform the method according to the above first aspect.

According to a fifth aspect of the disclosure, there is provided a communication device. The communication device may comprise a first determination module for when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, determining that an attack has occurred on the communication device.

In an embodiment of the disclosure, the communication device may further comprise a second determination module for, when the first determination module determines that an attack has occurred on the communication device, determining an ACL that is to be applied to a forwarding plane of the communication device to drop at least one ESP packet related to the attack, based on the anti-replay window by which the attack is determined to have occurred on the communication device or based on the duplicate SN. The communication device may further comprise a control module for applying the ACL to the forwarding plane.

In an embodiment of the disclosure, when a number of ESP packets dropped by the forwarding plane according to the ACL does not increase in a second predetermined time period, or when rekeying occurs, the control module may remove the ACL from the forwarding plane.

In an embodiment of the disclosure, when the first determination module determines that a new attack different than a previous attack has occurred on the communication device, the second determination module may determine an updated ACL that is to be applied to the forwarding plane to drop at least one ESP packet related to both the new attack and the previous attack, based on a new anti-replay window by which the new attack is determined to have occurred on the communication device or based on a new duplicate SN. The control module may apply the updated ACL to the forwarding plane.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating the problem in the existing solution for communication security;

FIG. 2 is a diagram illustrating an exemplary scenario into which an embodiment of the disclosure is applicable;

FIG. 3 is a flowchart illustrating a method performed by a communication device according to an embodiment of the disclosure;

FIG. 4 is a flowchart illustrating a method performed by a communication device according to an embodiment of the disclosure;

FIG. 5 is a flowchart illustrating a method performed by a communication device according to an embodiment of the disclosure;

FIG. 6 is a flowchart illustrating a method performed by a communication device according to an embodiment of the disclosure;

FIG. 7 is a flowchart illustrating an exemplary process according to an embodiment of the disclosure;

FIG. 8 is a flowchart illustrating an exemplary process according to an embodiment of the disclosure;

FIG. 9 is a block diagram showing an apparatus suitable for use in practicing some embodiments of the disclosure; and

FIG. 10 is a block diagram showing a communication device according to an embodiment of the disclosure.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

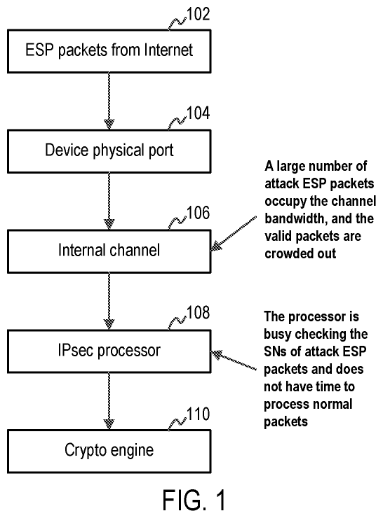

FIG. 1 illustrates the general ESP packet processing flow in the existing solution for communication security. As shown, the ESP packets 102 from the Internet are received by the device physical port 104 and delivered to the IPsec processor 108 via the internal channel 106. As described above, in order to prevent attacks, the ESP standard protocol defines SN (and ESN) and anti-replay window mechanisms to detect (and mitigate) attacks. On the receiving device side (specifically, at the IPsec processor), it is checked whether the SN of the received packet is repeated. If the SN is repeated, the packet is considered as an attack packet and is to be discarded.

If the first step is successful, it is checked whether the SN of the received ESP packet falls within the sliding window (the sliding window varies with the SN of the received valid ESP packet). If the SN of the received ESP packet does not fall within the sliding window, the packet is considered as an attack packet and is to be discarded.

If the first two steps are successful, the integrity of ESP packets is verified. This step is not discussed in this disclosure because it must be done anyway according to the standards.

As described above, the existing mechanism discovers the existence of the attack and discards the attack packet as soon as possible to avoid resource waste caused by decrypting the attack packet (by e.g. the crypto engine 110), but ignores the cost of the above procedure itself. The checking of every packet occurs on the processor (typically a central processing unit (CPU)), and the attack packets are delivered through the internal forwarding channels to the processor. Thus, it still has a great impact on the stability and security of the equipment.

In today's industry, it is not uncommon for the IPsec throughput of a single device to exceed 10 G. The inventors of the disclosure made an experiment simulating the attack packets which triggered the SN/anti-replay window mechanism. When the rate of attack packets exceeded 1G bit per second (bps), a large number of CPU utility and forwarding channel bandwidth were occupied and normal packets could hardly be processed.

The present disclosure proposes an improved solution for communication security. One of the basic ideas lies in more accurate detection of the existence of an attack. For example, the attack can be the packet's SN exceeding the anti-replay window more than a predetermined number of times in a predetermined period of time, or the packet's SN being not first seen in the security association (SA). Another basic idea is to deliver an ACL (e.g. containing qualification rules) to the forwarding plane after an attack is detected, so that the forwarding plane (e.g. in hardware and/or software) can filter out invalid packets. This can advance the filtering point of attack packets to protect the key processor and forwarding channel resources. Optionally, the ACL may be deleted or updated at an appropriate time, because for almost all chips, ACL resources are limited and it is best not to use them indefinitely.

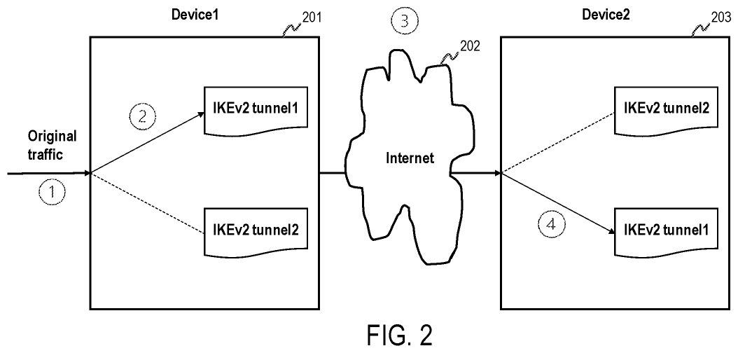

Hereinafter, the solution will be described in detail with reference to FIGS. 2-10. FIG. 2 is a diagram illustrating an exemplary scenario into which an embodiment of the disclosure is applicable. As shown, two communication devices 201 and 203 are connected via the Internet 202. The communication device 201 or 203 may be any communication device which can support IPsec. In this exemplary scenario, at step 1, the original traffic which is clear text may be obtained. It may be received from another device (e.g. in the case that the communication device 201 is a security gateway, or a firewall device, or the like), or may be generated by the communication device 201 internally (e.g. in the case that the communication device 201 is a user equipment (UE), a wired communication device, or the like).

At step 2, the original traffic is provided to an Internet key exchange protocol version 2 (IKEv2) tunnel (indicated as IKEv2 tunnel1 in the figure) to do encryption. At step 3, the encrypted packets are sent to the communication device 203 via the untrusted Internet 202. At step 4, the encrypted packets are provided to the corresponding IKEv2 tunnel according to the security parameters index (SPI) to do decryption. Then, the decrypted packets may be provided to the corresponding application.

Within the context of this disclosure, the term UE may also be referred to as, for example, terminal device, access terminal, device, mobile station, mobile unit, subscriber station, or the like. It may refer to any end device that can access a wireless communication network and receive services therefrom. By way of example and not limitation, the UE may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

In an Internet of things (IoT) scenario, a UE may represent a machine or other device that performs monitoring and/or measurements, and transmits the results of such monitoring and/or measurements to another UE and/or a network equipment. In this case, the UE may be a machine-to-machine (M2M) device, which may, in a 3GPP context, be referred to as a machine-type communication (MTC) device. Particular examples of such machines or devices may include sensors, metering devices such as power meters, industrial machineries, bikes, vehicles, or home or personal appliances, e.g. refrigerators, televisions, personal wearables such as watches, and so on.

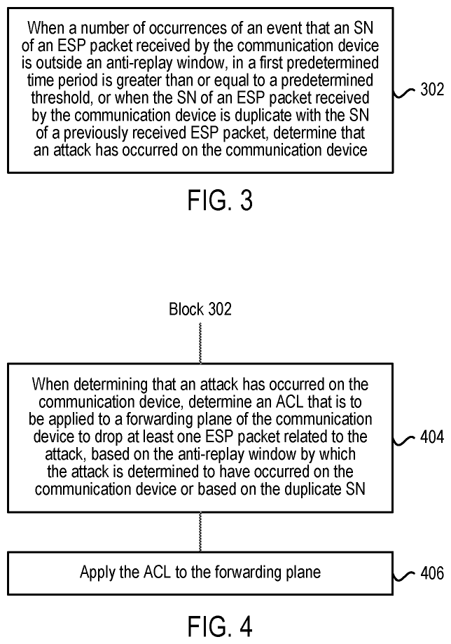

FIG. 3 is a flowchart illustrating a method performed by a communication device according to an embodiment of the disclosure. The communication device may be any communication device capable of supporting IPSec. Examples of the communication device may include, but not limited to, a security gateway, a firewall, a router, a server, a UE (or a terminal device), etc. At block 302, when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, the communication device determines that an attack has occurred on the communication device.

The use of the predetermined threshold for evaluating the number of occurrences of the event in the first predetermined time period is based on the following considerations. The existing SN combined with the anti-replay window mechanism could detect the validity of each packet and process the packet accordingly. However, the information about respective packets is not summarized (or is not considered in combination). In the actual network, due to e.g. congestion or forwarding path changes, the case that the anti-replay window is exceeded may occur occasionally. For example, in the following cases, the normal IPsec packets could exceed the anti-replay window: 1) there are multiple forwarding paths, such as in link aggregation scenario; 2) fragmentation is applied on the IPsec packets; 3) quality of service (QoS) function of the devices (e.g. routers) on the forwarding paths of the packets leads to packet delay. However, the case that the anti-replay window is exceeded should not happen frequently. In view of this, the predetermined threshold (which is a rate threshold) is set to effectively avoid treating (or misidentifying) normal IPsec packets that exceed anti-replay window as attacks. This can effectively improve the existing standard loopholes. As an exemplary example, if the SN exceeds the anti-replay window more than 10 times in 10 seconds, such case can be identified as an attack. The exact values of the predetermined threshold and the first predetermined time period may be configurable depending on the specific implementation, so as to increase flexibility.

On the other hand, duplicated SN of ESP packets at the same time is never allowed. Thus, an attack is determined to have occurred if either of the above two conditions is met. With the method of FIG. 3, it is possible to detect the attack more accurately thereby reducing false detection probability.

FIG. 4 is a flowchart illustrating a method performed by a communication device according to an embodiment of the disclosure. As shown, the method comprises block 302 described above and blocks 404-406. At block 302, when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, the communication device determines that an attack has occurred on the communication device. At block 404, when determining that an attack has occurred on the communication device, the communication device determines an access control list (ACL) that is to be applied to a forwarding plane of the communication device to drop at least one ESP packet related to the attack, based on the anti-replay window by which the attack is determined to have occurred on the communication device or based on the duplicate SN. The forwarding plane may be implemented by software, or a switching chip, or a network processor (NP), or any other suitable way. For the software, it can support the ACL. For the switching chip, it can also support the ACL since almost all switching chips (e.g. in the form of application specific integrated circuit (ASICs)) support user defined rules. For NP chips which are programmable forwarding chips, it can also support the ACL.

For example, the ACL may instruct the forwarding plane to drop at least one ESP packet satisfying following conditions: 1) a security parameters index (SPI) value of the at least one ESP packet is equal to the SPI value of a security association (SA) for which the attack is determined to have occurred on the communication device; 2) a source IP address of the at least one ESP packet is the same as the source IP address of the SA; 3) a destination IP address of the at least one ESP packet is the same as the destination IP address of the SA; and 4) the SN of the at least one ESP packet is less than a lower edge of the anti-replay window by which the attack is determined to have occurred on the communication device, or is less than or equal to the duplicate SN. The SPI is an identification tag added to the header while using IPSec for tunneling the IP traffic, and can act as a unique identifier for an IPsec connection. The SA is the establishment of shared security attributes between two network entities to support secure communication.

In the case where the attack is determined based on the number of occurrences of the event in the first predetermined time period, the above condition 4) may be that the SN of the at least one ESP packet is less than the lower edge of the anti-replay window by which the attack is determined to have occurred on the communication device. Although the SN and the anti-replay window exceeded by the SN may vary in these occurrences of the event, the anti-replay window moves on the axis of SN towards an increasing direction of SN. Thus, the lower edge of the anti-replay window used at the time when the attack is determined to have occurred (which may be called the anti-replay window by which the attack is determined to have occurred) is enough to act as the upper limit of the SN of the at least one ESP packet in the above condition 4).

In the case where the attack is determined based on the duplicate SN, the duplicate SN may be within the anti-replay window used at the time when the attack is determined to have occurred, or may be outside the anti-replay window used at the time when the attack is determined to have occurred. If the duplicate SN is within the anti-replay window used at the time when the attack is determined to have occurred, the above condition 4) may be that the SN of the at least one ESP packet is less than or equal to the duplicate SN. If the duplicate SN is outside the anti-replay window used at the time when the attack is determined to have occurred, the above condition 4) may be that the SN of the at least one ESP packet is less than the lower edge of the anti-replay window used at the time when the attack is determined to have occurred (which may also be called the anti-replay window by which the attack is determined to have occurred on the communication device).

Table 1 below shows the structure of an IP version 4 (IPv4)/IP version 6 (IPv6) ESP packet. The term “hdr” refers to header, and the term “ICV” refers to integrity check value. The SPI and the SN are contained in the “ESP” in Table 1 are disposed at the front portion of the “ESP”. According to the table below, the offset of SPI/SN of the IPv4/IPv6 ESP packet in an SA is fixed. Since the SPI value, SN value, source IP address and destination IP address can be found from the fixed positions of a packet, the ACL has a foundation for implementation. The IP addresses are considered in the ACL to avoid packets from being discarded by mistake.

TABLE 1
structure of IPv4/IPv6 ESP packet

| | | | | |
|---|---|---|---|---|
| new IP hdr* | ESP | Data | ESP | ESP |
| | | | Trailer | ICV |

At block 406, the communication device applies the ACL to the forwarding plane. For example, blocks 302 and 404 may be performed by a processor (e.g. a CPU) of the communication device. Then, the ACL may be delivered by the processor to the forwarding plane at block 406. With the method of FIG. 4, the normal ESP packets can be processed efficiently (by e.g. the processor) even when there are a large number of attack packets, since the attack packets are filtered out by the forwarding plane according to the ACL.

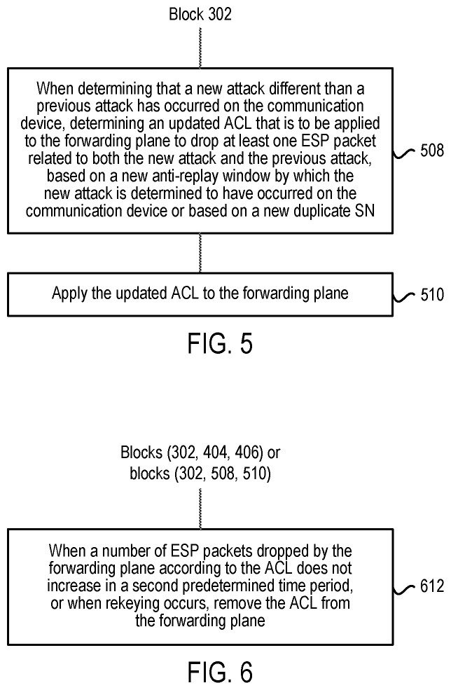

FIG. 5 is a flowchart illustrating a method performed by a communication device according to an embodiment of the disclosure. As shown, the method comprises block 302 described above and blocks 508-510. At block 302, when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, the communication device determines that an attack has occurred on the communication device. At block 508, when determining that a new attack different than a previous attack has occurred on the communication device, the communication device determines an updated ACL that is to be applied to the forwarding plane to drop at least one ESP packet related to both the new attack and the previous attack, based on a new anti-replay window by which the new attack is determined to have occurred on the communication device or based on a new duplicate SN.

For example, the updated ACL may instruct the forwarding plane to drop at least one ESP packet satisfying following conditions: 1) the SPI value of the at least one ESP packet is equal to the SPI value of the SA for which the new attack is determined to have occurred on the communication device; 2) the source IP address of the at least one ESP packet is the same as the source IP address of the SA; 3) the destination IP address of the at least one ESP packet is the same as the destination IP address of the SA; and 4) the SN of the at least one ESP packet is less than the lower edge of the new anti-replay window by which the new attack is determined to have occurred on the communication device, or is less than or equal to the new duplicate SN.

Similar to block 404, in the case where the new attack is determined based on the number of occurrences of the event in the first predetermined time period, the above condition 4) may be that the SN of the at least one ESP packet is less than the lower edge of the new anti-replay window by which the new attack is determined to have occurred on the communication device. Since the anti-replay window moves on the axis of SN towards an increasing direction of SN, the lower edge of the anti-replay window used at the time when the new attack is determined to have occurred (which may be called the new anti-replay window by which the new attack is determined to have occurred) is larger than the lower edge of the anti-replay window used at the time when the previous attack is determined to have occurred. Thus, the lower edge of the new anti-replay window is enough to act as the upper limit of the SN of the at least one ESP packet in the above condition 4).

In the case where the new attack is determined based on the new duplicate SN, the new duplicate SN may be within the anti-replay window used at the time when the new attack is determined to have occurred, or may be outside the anti-replay window used at the time when the new attack is determined to have occurred. If the new duplicate SN is within the anti-replay window used at the time when the new attack is determined to have occurred, the above condition 4) may be that the SN of the at least one ESP packet is less than or equal to the new duplicate SN. If the new duplicate SN is outside the anti-replay window used at the time when the new attack is determined to have occurred, the above condition 4) may be that the SN of the at least one ESP packet is less than the lower edge of the anti-replay window used at the time when the new attack is determined to have occurred (which may also be called the new anti-replay window by which the new attack is determined to have occurred on the communication device).

At block 510, the communication device applies the updated ACL to the forwarding plane. For example, blocks 302 and 508 may be performed by a processor (e.g. a CPU) of the communication device. Then, the updated ACL may be delivered by the processor to the forwarding plane at block 510. With the method of FIG. 5, the normal ESP packets can be processed efficiently (by e.g. the processor) even when there are a large number of attack packets, since the attack packets are filtered out by the forwarding plane according to the updated ACL.

FIG. 6 is a flowchart illustrating a method performed by a communication device according to an embodiment of the disclosure. As shown, the method comprises blocks (302, 404, 406) described above and block 612. Alternatively, the method comprises blocks (302, 508, 510) described above and block 612. At block 612, when a number of ESP packets dropped by the forwarding plane according to the ACL does not increase in a second predetermined time period, or when rekeying occurs, the communication device removes the ACL from the forwarding plane. The ACL mentioned in block 612 may cover the ACL applied for the first time at block 404, and the updated ACL at block 508. The rekeying refers to the creation of a new SA to take the place of an expiring SA before the SA expires. For example, blocks 302, 404-406 and 508-510 may be performed by a processor (e.g. a CPU) of the communication device. Then, the ACL may be removed by the processor at block 612 by sending a delete command to the forwarding plane. With the method of FIG. 6, it is possible to save the ACL resources available at the forwarding plane when the attack disappears or rekeying occurs.

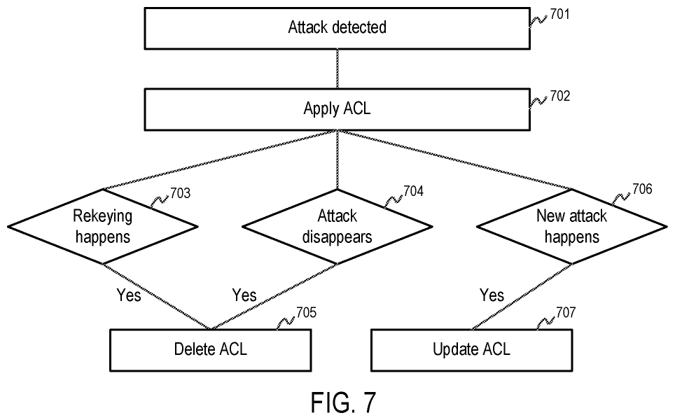

FIG. 7 is a flowchart illustrating an exemplary process according to an embodiment of the disclosure. At block 701, an attack is detected to have occurred at a communication device. For example, an attack is detected to have occurred if either of the following two conditions are met: 1) the number of times that the SN of an ESP packet exceeds the anti-replay window in a certain period of time exceeds a certain threshold; and 2) any duplicated SN occurs. At block 702, the ACL is applied to the forwarding plane of the communication device. For example, the qualification rules of the ACL may be as follows: 1) the SPI value of the ESP packet is equal to the SPI value of the current SA (the SA for which the attack is detected); 2) the source IP address of the ESP packet is the source IP address of the current SA; 3) the destination IP address of the ESP packet is the destination IP address of the current SA; 4) the SN value of the ESP packet is less than the lower edge of the current anti-replay window (the anti-replay window used at the time when the attack is detected) or is less than or equal to the duplicate SN.

For example, the qualification rule 4) can be implemented by using a data mask of the ACL. As an exemplary example for efficient use of ACL resources, the lower edge of the current anti-replay window may be divided into a sum of one or more powers of 2. For example, suppose the lower edge of the current anti-replay window is 1038. Then, 1038=1024+8+4+2. For each of factors that are powers of 2, an ACL based on mask can be applied. That is, the following 4 ACLs can be delivered to the forwarding plane:
1) ACL of 1024 (base 2), packet matching ACL needs to be discarded: 00000000000000000000001111111111 mask 11111111111111111111110000000000, meaning that if the first 22 bits (counting from the left side) of the SN of the packet is “0000000000000000000000” so that SN≤1023, the packet needs to be discarded;
2) ACL of 8 (base 2), packet matching ACL needs to be discarded: 00000000000000000000010000000111 mask 11111111111111111111111111111000, meaning that if the first 29 bits (counting from the left side) of the SN of the packet is “00000000000000000000010000000” so that 1024≤SN≤1031, the packet needs to be discarded;
3) ACL of 4 (base 2), packet matching ACL needs to be discarded: 00000000000000000000010000001011 mask 11111111111111111111111111111100, meaning that if the first 30 bits (counting from the left side) of the SN of the packet is “000000000000000000000100000010” so that 1032≤SN≤1035, the packet needs to be discarded;
4) ACL of 2 (base 2), packet matching ACL needs to be discarded: 00000000000000000000010000001101 mask 11111111111111111111111111111110, meaning that if the first 31 bits (counting from the left side) of the SN of the packet is “0000000000000000000001000000110” so that 1036≤SN≤1037, the packet needs to be discarded.
   Note that when the upper limit is set based on the duplicate SN in the qualification rule 4), the ACL can be generated in a similar way. Also Note that the above qualification rule 4) may be generated in any other suitable way.

The action corresponding to the ACL is to drop the hit packets. The effect brought by the ACL is that attack packets can be discarded by the forwarding plane and are not sent to the processor. This can protect the internal forwarding channel and the processor's resources and ensure that normal packets can be processed.

At block 703, it is determined whether rekeying happens. When rekeying happens, the SN of the SA needs to be reset to 0 according to protocol requirements. Thus, the ACL needs to be deleted. At block 704, it is determined whether the attack disappears. If the determination result at block 703 or 704 is positive, the process proceeds to block 705 where the ACL is deleted.

At block 706, it is detected whether new attack happens. If it is detected that new attack happens, the process proceeds to block 707 where the ACL is updated. Blocks 706 and 707 are based on the following considerations. After the ACL is applied, all ESP packets (attack packets) whose SN is smaller than the lower edge of the anti-replay window are discarded by the forwarding plane. In principle, the processor does not receive any attack packets. But the SN of new attack ESP packet cannot be discarded by the forwarding plane because the SN exceeds the filtering range of the ACL. This kind of event can be detected in the same way as described above with respect to block 701 and it is necessary to update the ACL.

For example, the new filtering rules may be as follows: 1) the SPI value of the ESP packet is equal to the SPI value of the current SA (the SA for which the new attack is detected); 2) the source IP address of the ESP packet is the source IP address of the current SA; 3) the destination IP address of the ESP packet is the destination IP address of current SA; 4) the SN value of the ESP packet is less than the lower edge of the current anti-replay window. Note that the lower edge of the anti-reply window is current, meaning it is a new anti-replay window. Since the anti-replay window is a sliding window, the lower edge of the current window must be larger than the lower edge of the window in the old ACL. Therefore, the new ACL can contain the old ACL, meaning that only the new ACL is sufficient.

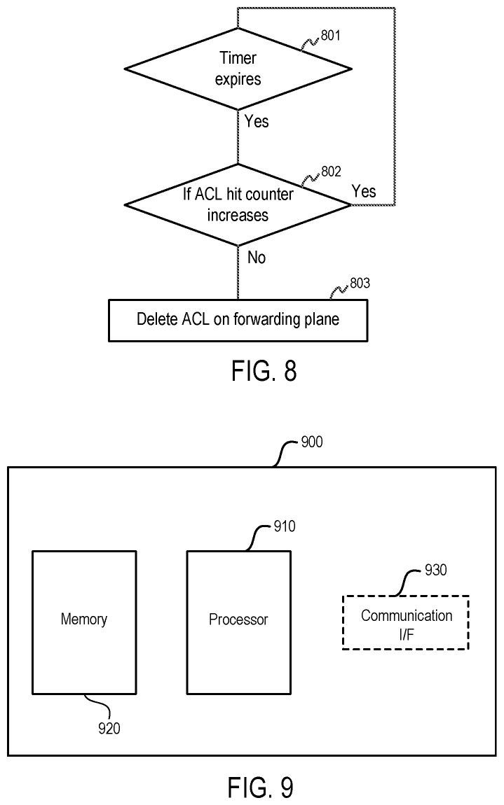

FIG. 8 is a flowchart illustrating an exemplary process according to an embodiment of the disclosure. This process is employed in consideration of the fact that the attack may disappear after a period of time, so it needs to delete the ACL rules after confirming that the attack does not occur, so as to avoid permanently occupying ACL resources. To determine the disappearance of an attack, it is periodically checked whether the ACL hit counter has increased within a certain period. For example, at block 801, it is checked whether a timer having a predetermined expiry time has expired. If the timer has expired, it is checked whether the ACL hit counter has increased. If the ACL hit counter has increased, the timer is restarted so that block 801 is periodically performed again. On the other hand, if there is no increase of the ACL hit counter within the certain period (e.g., 10 minutes, note that it is a configurable parameter), the attack is considered to disappear and the ACL is deleted from the forwarding plane at block 803.

FIG. 9 is a block diagram showing an apparatus suitable for use in practicing some embodiments of the disclosure. For example, the communication device described above may be implemented through the apparatus 900. As shown, the apparatus 900 may include a processor 910, a memory 920 that stores a program, and optionally a communication interface 930 for communicating data with other external devices through wired and/or wireless communication.

The program includes program instructions that, when executed by the processor 910, enable the apparatus 900 to operate in accordance with the embodiments of the present disclosure, as discussed above. That is, the embodiments of the present disclosure may be implemented at least in part by computer software executable by the processor 910, or by hardware, or by a combination of software and hardware.

The memory 920 may be of any type suitable to the local technical environment and may be implemented using any suitable data storage technology, such as semiconductor based memory devices, flash memories, magnetic memory devices and systems, optical memory devices and systems, fixed memories and removable memories. The processor 910 may be of any type suitable to the local technical environment, and may include one or more of general purpose computers, special purpose computers, microprocessors, digital signal processors (DSPs) and processors based on multi-core processor architectures, as non-limiting examples.

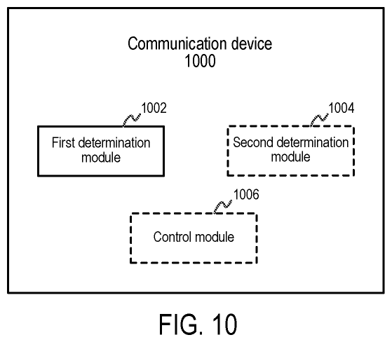

FIG. 10 is a block diagram showing a communication device according to an embodiment of the disclosure. As shown, the communication device 1000 at least comprises a first determination module 1002. The first determination module 1002 may be configured to, when a number of occurrences of an event that an SN of an ESP packet received by the communication device is outside an anti-replay window, in a first predetermined time period is greater than or equal to a predetermined threshold, or when the SN of an ESP packet received by the communication device is duplicate with the SN of a previously received ESP packet, determine that an attack has occurred on the communication device, as described above with respect to block 302.

Optionally, the communication device 1000 may further comprise a second determination module 1004 and a control module 1006. The second determination module 1004 may be configured to, when the first determination module 1002 determines that an attack has occurred on the communication device, determine an ACL that is to be applied to a forwarding plane of the communication device to drop at least one ESP packet related to the attack, based on the anti-replay window by which the attack is determined to have occurred on the communication device or based on the duplicate SN, as described above with respect to block 404. The control module 1006 may be configured to apply the ACL to the forwarding plane, as described above with respect to block 406.

Optionally, the second determination module 1004 may be further configured to, when the first determination module determines that a new attack different than a previous attack has occurred on the communication device, determine an updated ACL that is to be applied to the forwarding plane to drop at least one ESP packet related to both the new attack and the previous attack, based on a new anti-replay window by which the new attack is determined to have occurred on the communication device or based on a new duplicate SN, as described above with respect to block 508. The control module 1006 may be further configured to apply the updated ACL to the forwarding plane, as described above with respect to block 510.

Optionally, the control module 1006 may be further configured to, when a number of ESP packets dropped by the forwarding plane according to the ACL does not increase in a second predetermined time period, or when rekeying occurs, remove the ACL from the forwarding plane, as described above with respect to block 612. The modules described above may be implemented by hardware, or software, or a combination of both.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1.-17. (canceled)

18. A method performed by a communication device, comprising:
determining that an attack on the communication device has occurred, responsive to:
receiving at least a threshold amount of encapsulated security packets (ESPs) with sequence numbers (SNs) that are outside of an anti-replay window; or
receiving an ESP packet with a SN that is a duplicate of a previously received ESP packet.

19. The method according to claim 18, further comprising applying an access control list (ACL) to a forwarding plane of the communication device in response to the attack, the ACL being configured to drop at least one ESP packet related to the attack.

20. The method according to claim 19, wherein the ACL instructs the forwarding plane to drop the ESP packets satisfying following conditions:
a security parameters index (SPI) value of the ESP packets is equal to the SPI value of a security association (SA) for which the attack is determined to have occurred on the communication device;
a source Internet protocol (IP) address of the ESP packets is the same as the source IP address of the SA;
a destination IP address of the at least one ESP packet is the same as the destination IP address of the SA; and
the SNs of the ESP packets is less than a lower edge of the anti-replay window by which the attack is determined to have occurred on the communication device, or is less than or equal to the duplicate SN.

21. The method according to claim 19, further comprising removing the ACL from the forwarding plane responsive to rekeying occurring or the number of ESP packets dropped according to the ACL not increasing over a defined time period.

22. The method according to claim 19, further comprising updating the ACL in response to detecting a new attack, the updated ACL being configured to drop ESP packets related to the attack as previously determined, and related to the new attack.

23. The method according to claim 22, wherein the updated ACL is updated to add instructions for dropping ESP packets that satisfy the following conditions:
the SPI value of the ESP packets is equal to the SPI value of the SA for which the new attack is determined to have occurred on the communication device;
the source IP address of the at least one ESP packet is the same as the source IP address of the SA;
the destination IP address of the at least one ESP packet is the same as the destination IP address of the SA; and
the SN of the ESP packets is less than the lower edge of a new anti-replay window by which the new attack is determined to have occurred on the communication device, or is less than or equal to a new duplicate SN detected for the new attack.

24. The method according to claim 18, wherein the communication device is configured to support Internet protocol security (IPSec).

25. The method according to claim 18, wherein the communication device is one of:
a security gateway;
a firewall;
a router;
a server; or
a user equipment.

26. A communication device comprising:
at least one processor; and
at least one memory, the at least one memory containing instructions executable by the at least one processor, whereby the communication device is operative to:
when a number of occurrences of an event that a sequence number (SN) of an encapsulating security payload (ESP) packet received by the communication device is outside an anti-replay window, in a first predetermined time period is greater than or equal to a predetermined threshold, or when the SN of an ESP packet received by the communication device is duplicate with the SN of a previously received ESP packet, determine that an attack has occurred on the communication device.

27. The communication device according to claim 26, wherein the communication device is further operative to:
when determining that an attack has occurred on the communication device, determine an access control list (ACL) that is to be applied to a forwarding plane of the communication device to drop at least one ESP packet related to the attack, based on the anti-replay window by which the attack is determined to have occurred on the communication device or based on the duplicate SN; and
apply the ACL to the forwarding plane.

28. The communication device according to claim 27, wherein the ACL instructs the forwarding plane to drop at least one ESP packet satisfying following conditions:
a security parameters index (SPI) value of the at least one ESP packet is equal to the SPI value of a security association (SA) for which the attack is determined to have occurred on the communication device;
a source Internet protocol (IP) address of the at least one ESP packet is the same as the source IP address of the SA;
a destination IP address of the at least one ESP packet is the same as the destination IP address of the SA; and
the SN of the at least one ESP packet is less than a lower edge of the anti-replay window by which the attack is determined to have occurred on the communication device, or is less than or equal to the duplicate SN.

29. The communication device according to claim 27, wherein the communication device is further operative to:
when a number of ESP packets dropped by the forwarding plane according to the ACL does not increase in a second predetermined time period, or when rekeying occurs, remove the ACL from the forwarding plane.

30. The communication device according to claim 27, wherein the communication device is further operative to:
when determining that a new attack different than a previous attack has occurred on the communication device, determine an updated ACL, that is to be applied to the forwarding plane to drop at least one ESP packet related to both the new attack and the previous attack, based on a new anti-replay window by which the new attack is determined to have occurred on the communication device or based on a new duplicate SN; and
apply the updated ACL to the forwarding plane.

31. The communication device according to claim 30, wherein the updated ACL instructs the forwarding plane to drop at least one ESP packet satisfying following conditions:
the SPI value of the at least one ESP packet is equal to the SPI value of the SA for which the new attack is determined to have occurred on the communication device;
the source IP address of the at least one ESP packet is the same as the source IP address of the SA;
the destination IP address of the at least one ESP packet is the same as the destination IP address of the SA; and
the SN of the at least one ESP packet is less than the lower edge of the new anti-replay window by which the new attack is determined to have occurred on the communication device, or is less than or equal to the new duplicate SN.

32. The communication device according to claim 26, wherein the communication device is configured to support Internet protocol security (IPSec).

33. The communication device according to claim 26, wherein the communication device is one of:
a security gateway;
a firewall;
a router;
a server; or
a user equipment.
